(19) United States
(12) Patent Application Publication
(10) Pub. No.: US 2013/0073139 A1
(43) Pub. Date: Mar. 21, 2013

(54) METHODS AND SYSTEMS FOR CONTROLLING ENGINE OPERATION THROUGH DATA-SHARING AMONG VEHICLES

(71) Applicants: Luke HENRY, Lawrence Park, PA (US); Patricia Lacy, Lawrence Park, PA (US)

(72) Inventors: Luke HENRY, Lawrence Park, PA (US); Patricia Lacy, Lawrence Park, PA (US)

(21) Appl. No.: 13/239,292

(22) Filed: Sep. 21, 2011

(51) Int. Cl. G06F 7/00

(52) U.S. Cl. 701/29.3

(57) ABSTRACT

Various embodiments of methods and system are provided for enhancing engine operation through data-sharing among vehicles. In one embodiment, a method includes determining whether a first value of an operating parameter indicative of an ambient environmental condition produced by a first vehicle is corrupted or unavailable, receiving a second value of the operating parameter that is indicative of the ambient environmental condition produced by a second vehicle that is proximate to the first vehicle, and in response to determining that the first value is corrupted or unavailable, controlling operation of an engine of the first vehicle based on the second value of the operating parameter.

### FIELD

Embodiments of the subject matter disclosed herein relate to engines. Other embodiments relate to engine control.

### BACKGROUND

Some vehicles, such as rail vehicles, employ back-up models for operating parameters that are utilized to control vehicle operation in the event that a signal provided by a sensor, or the like, is corrupted or unavailable. Typically, a back-up model is generated by an on-board controller of a vehicle to enable the vehicle to continue operation based on the back-up model in the event of sensor failure.

In one example, operation of a rail vehicle is controlled based on barometric pressure that is indicated by a signal received from a barometric pressure sensor. If the barometric pressure sensor fails, a back-up model of barometric pressure is employed that uses an intake manifold air pressure measured during a last time that the rail vehicle was at idle, or defaults to a designated value for maximum engine protection. Neither of these back-up models provides operating parameter data that is indicative of current ambient environmental conditions, and thus is less accurate and dependable than signals provided from a healthy barometric pressure sensor. For example, the designated value of the back-up model significantly de-rates power output of the engine for protection purposes. Accordingly, operation of the rail vehicle based on the back-up model may be limited or less efficient relative to operation based on sensor signal data.

### BRIEF DESCRIPTION

In one embodiment, a method includes determining whether a first value of an operating parameter is corrupted or unavailable. The operating parameter is indicative of an ambient environmental condition, and the first value is produced by a first vehicle. The method further includes receiving a second value of the operating parameter indicative of the ambient environmental condition. The second value is produced by a second vehicle that is proximate to the first vehicle. The method further includes, in response to determining that the first value is corrupted or unavailable, controlling operation of an engine of the first vehicle based on the second value of the operating parameter.

Since vehicles that are proximate to each other are exposed to similar environmental conditions, operating parameters that are detected by one vehicle may be passed to and learned by another, proximate vehicle. Thus, in the event that a sensor signal at a vehicle is unavailable or corrupted, a value of an equivalent sensor signal provided by a different vehicle may be utilized for control of the vehicle. The shared value of the operating parameter may be a more accurate indication of ambient environmental conditions than a modeled value of the operating parameter that is provided as back-up. Accordingly, by leveraging operating parameter data-sharing between vehicles, vehicle operation may be made more robust and effective.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a schematic diagram of an embodiment of a vehicle according to the present disclosure.

FIG. 2 shows a schematic diagram of an embodiment of a train including a plurality of rail vehicles.

FIG. 3 shows a flow chart illustrating an embodiment of a method for controlling vehicle operation based on data shared between proximate vehicles.

FIG. 4 shows a flow chart illustrating an embodiment of a method for controlling engine operation during tunneling operation.

FIG. 5 shows a flow chart illustrating an embodiment of a method for controlling engine operation in an identified geographic area.

FIG. 6 shows a flow chart illustrating an embodiment of a method for diagnosing sensor signal corruption.

### DETAILED DESCRIPTION

The following description relates to various embodiments of systems and methods for enhancing engine operation through data-sharing among vehicles. In one embodiment, a system includes a first vehicle, proximate to a second vehicle. The first vehicle includes an engine, a sensing device, a communication device, and a controller. The sensing device is operable to produce a first value of an operating parameter that is indicative of an environmental condition. The communication device is operable to receive a second value of the operating parameter that is indicative of the environmental condition produced by the second vehicle. The controller is operable to determine whether the first value of the operating parameter is corrupted or unavailable. In response to determining that the first value of the operating parameter is corrupted or unavailable, the controller is operable to control operation of the engine based on the second value of the operating parameter.

In such a configuration, operating parameter values are effectively learned from another vehicle that shares the same or similar ambient environmental conditions due to their proximity, through data-sharing. Accordingly, having to use less accurate back-up values (e.g., that are not modeled based on ambient environmental conditions) can be avoided in the event of sensor signal corruption or unavailability. As used herein, the term “environmental conditions” defines conditions that are external to and within proximity to a vehicle. Examples of operating parameters that are indicative of environmental conditions that may be shared between proximate vehicles include travel speed restrictions, emissions restrictions, track grade, environmental traits (e.g., presence of a tunnel, etc.). Moreover, ambient environmental conditions are a subset of environmental conditions. As used herein, the term “ambient environmental conditions” defines conditions of the atmosphere surrounding a vehicle. Examples of operating parameters that are indicative of ambient environmental conditions that may be shared between proximate vehicles include ambient temperature, barometric (ambient) pressure, constituents of gas external to a vehicle, and ambient humidity. Sharing of such operating parameters between vehicles may enable more robust or enhanced engine operation relative to engine operation based on back-up modeled data that does not consider environmental conditions.

The approach described herein may be employed in a variety of engine types, and a variety of engine-driven systems, including vehicles that are proximate to each other, such as vehicles connected in a consist. In one example, proximate vehicles may include a first vehicle coupled in a train with a second vehicle coupled in the train, where a number of vehicles in between the first and second vehicle is less than a selected number, such as ten vehicles, although other numbers may be used. Alternatively, proximate vehicles may include a first vehicle coupled in a train with a second vehicle coupled in the train, where a distance between the first and second vehicles is less than a threshold distance, such as 100 meters, although other distances may be used. According to another aspect, first and second vehicles may be considered proximate, for purposes of the first vehicle using sensor data received from the second vehicle for engine control purposes, if the sensor data from the second vehicle is applicable to operations of the first vehicle within a designated error threshold, which may be different for different sensed conditions.

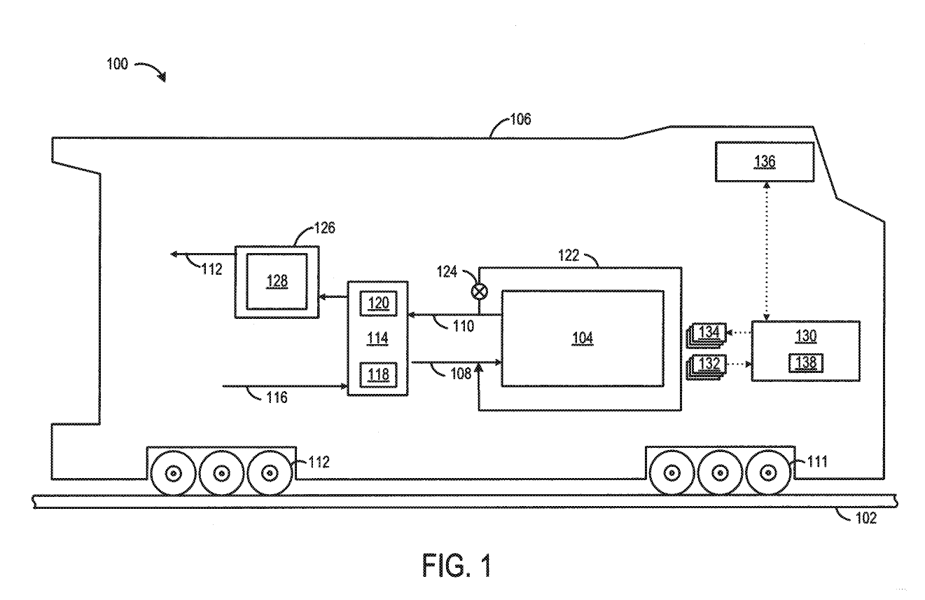

For clarity of illustration, locomotives or other rail vehicles are provided as examples of vehicles that may be outfitted with, and/or controlled according to, different embodiments. FIG. 1 shows a block diagram of an exemplary embodiment of a vehicle system 100, herein depicted as a rail vehicle 106 (e.g., locomotive), configured to run on a rail 102 via a plurality of wheels 111. As depicted, the rail vehicle 106 includes an internal combustion engine 104. In other non-limiting embodiments, the engine 104 may be an engine in a marine vessel, other off-highway vehicle propulsion system, or another system that includes a plurality of vehicles that are proximate or connected to each other and share engine and/or operating data.

The engine 104 receives intake air for combustion from an intake manifold 108. Exhaust gas resulting from combustion in the engine 104 is supplied to an exhaust passage 110. Exhaust gas flows through the exhaust passage 110, and out of an exhaust stack 112 of the rail vehicle 106. In one example, the engine 104 is a diesel engine that combusts air and diesel fuel through compression ignition. In other non-limiting embodiments, the engine 104 may combust fuel including natural gas or gasoline, kerosene, biodiesel, or other petroleum distillates of similar density through compression ignition (and/or spark ignition).

A turbocharger 114 is arranged between an intake passage 116 and the exhaust passage 110. Ambient air passes through the intake passage 116 to a compressor 118 of the turbocharger 114. The compressor 118 of the turbocharger 114 increases air charge of ambient air to provide greater charge density during combustion to increase power output and/or engine-operating efficiency. The compressor 118 is at least partially driven by a turbine 120, which is disposed in the engine exhaust stream and driven by the engine exhaust stream. While in this case a single turbocharger is included, the vehicle system 100 may include multiple turbine and/or compressor stages.

An EGR passage 122 is coupled between the exhaust passage 110 and the intake manifold 108. The EGR passage 122 routes exhaust gas from the exhaust passage 110 to the intake manifold 108 of the engine 104, and not to atmosphere. By introducing exhaust gas to the engine 104, the amount of available oxygen for combustion is decreased, thereby reducing combustion flame temperatures and reducing the formation of nitrogen oxides (e.g., NOₓ).

An EGR valve 124 is positioned between the exhaust passage 110 and the EGR passage 122. The EGR valve 124 may be an on/off valve, or it may control a variable amount of EGR, for example. In some examples, the EGR valve 124 may be actuated such that an EGR amount that flows to the intake manifold 108 is reduced. In other examples, the EGR valve 124 may be actuated such that the EGR amount that flows to the intake manifold 108 is increased. It should be understood, the EGR valve 124 may be any element that can be controlled to selectively partially or completely block a passage. As an example, the EGR valve may be a gate valve, a butterfly valve, a globe valve, an adjustable flap, or the like.

In the illustrated embodiment, the EGR passage 122 provides high-pressure EGR gas to the intake manifold 108. In other embodiments, the vehicle system 100 may additionally or alternatively include a low-pressure EGR system, routing EGR gas from downstream of the turbine 120 to upstream of the compressor 118. In some embodiments, the vehicle system 100 may include a plurality of EGR valves to control the amount of EGR.

An aftertreatment system 126 is coupled in the exhaust passage 110 downstream of the turbine 120. The aftertreatment system 126 may include one or more aftertreatment devices 128. In one embodiment, the aftertreatment system 126 includes a diesel particulate filter (DPF). In other embodiments, the aftertreatment system 126 additionally or alternatively includes a diesel oxidation catalyst (DOC), a selective catalytic reduction (SCR) catalyst, a three-way catalyst, a NOₓ trap, or various other emission control devices or combinations thereof. The DPF may be cleaned via regeneration, which may be employed as active regeneration by increasing the temperature for burning particulate matter that has collected in the filter through adjustment of engine operation. In particular, during active regeneration, air-fuel ratio or other operating parameters may be adjusted and/or fuel may be injected and burned in the exhaust passage upstream of the DPF in order to drive the temperature of the DPF up to a temperature where the particulate matter will burn. Passive regeneration may occur when a temperature of the exhaust gas is high enough to burn the particulate matter in the filter.

A controller 130 is operable to control various components related to the vehicle system 100. In one example, the controller 130 is a microcomputer, including microprocessor unit, input/output ports, an electronic storage medium (e.g., read-only memory), random access memory, non-volatile memory, and a data bus. In some embodiments, the electronic storage medium is programmable with computer readable data representing instructions executable by the processor for performing the methods described below as well as other variants that are anticipated but not specifically listed. The controller 130 is operable to monitor and control vehicle operation.

The controller 130, while overseeing control and management of the vehicle system 100, is operable to receive signals from a variety of sensing devices 132, as further elaborated herein, in order to determine operating parameters and environmental conditions, and correspondingly adjust various actuators 134 to control operation of the vehicle system 100. Each of the sensing devices 132 is operable to sense a condition and to produce a value of the sensed condition, for use as an operating parameter, in the form of a sensor signal that is sent to the controller 130. For example, the controller 130 may receive signals from various engine sensors that sense conditions including, but not limited to, ambient temperature, barometric pressure, engine speed, engine load, boost pressure, exhaust pressure, exhaust temperature, intake oxygen concentration, exhaust oxygen concentration, etc. Correspondingly, the controller 130 may control the vehicle system 100 by sending commands to various components such as traction motors, alternator, cylinder valves, throttle, etc. based on the operating parameters including those received from the engine sensors.

As another example, one of the sensing devices 132 includes a global positioning system (GPS) receiver. The controller 130 may determine (e.g., through estimation or calculation) a geographic position (e.g., coordinates) of the vehicle system 100 using signals from GPS receiver. Geographic features in the path of the vehicle system 100, such as features on or around the rail 102 of the rail vehicle 106, may be signaled by an operator or calculated. In some implementations, the controller 130 includes a route-feature database 138. The route-feature database 138 may include information describing different features and regulations that may be considered as environmental conditions on a route of the vehicle system 100. For example, designated geographic features and their respective GPS positions may be stored in the route-feature database 138. A distance between the rail vehicle 106 and the any one of the set of designated geographic features may be calculated so that the nearest geographic feature and its distance may be determined. Non-limiting examples of geographic features that may be stored in a set of designated geographic features include a tunnel, a tunnel entrance, a tunnel exit, a geographic region having different emissions restrictions, a steep grade, a city boundary, and a restricted speed boundary. Further, the route-feature database 138 may include stored information about the predefined geographic features, such as length of a tunnel and grade of the tunnel.

A communication device 136 is operable to send and receive information, such as values of operating parameters, between vehicle systems that are proximate to and/or operatively coupled with the vehicle system 100. In some embodiments, the communication device 136 includes a wired communication link. In one example, the wired link includes communication over a multiple unit cable that is coupled between one or more rail vehicle in a consist. In some embodiments, the communication device 136 includes a wireless communication link. In one example, the wireless link includes a wireless modem or data radio that enables access to a local wireless network through which data may be shared between proximate vehicles. It will be appreciated that the communication link enables data-sharing between vehicles that are directly coupled together. Additionally or alternatively, the communication link enables data-sharing between vehicles that are proximate to each other, but are not directly coupled together, such as rail vehicles distributed throughout a train.

As discussed above, since vehicles that are proximate to each other may experience substantially the same or similar environmental conditions, some conditions sensed by sensing devices on one vehicle may accurately define the environmental conditions of a proximate vehicle, and may be used as operating parameters for the proximate vehicle. As such, operating parameters and/or associated data may be shared between vehicles through the communication device 136, and may be leveraged by each of the vehicles to enhance vehicle operation. In particular, the communication device 136 is operable to send values of operating parameters received from other, proximate vehicles to the controller 130, and the controller 130 is operable to control vehicle operation based on the received values of the operating parameters, under some conditions.

For example, the controller 130 may utilize the received values of the operating parameters from other vehicles for diagnostic purposes. In one example, the controller 130 is operable to determine whether a first value of an operating parameter is corrupted or unavailable. The first value of the operating parameter may be generated on-board, for example, by a sensing device 132 of the vehicle system 100. The controller 130 is further operable to, in response to determining that the first value of the operating parameter is corrupted or unavailable, control operation of the engine 104 based on a second value of the operating parameter that is received from another vehicle through the communication device 136. (An operating parameter is a category or type of condition used as a basis for vehicle operation, e.g., engine control. Thus, a sensed condition is an operating parameter if it is used for engine control or otherwise for vehicle control, in a given vehicle system.)

In some embodiments, the controller 130 is operable to receive values of the same operating parameter from different vehicles that are proximate or in the consist with the vehicle system 100, through the communication device 136. In some embodiments, the controller 130 is operable to compare the different values to determine whether any of the values are inaccurate or corrupted. In one particular example, the controller 130 is operable to compare a first value of an operating parameter that is generated by or at the vehicle system 100 (first vehicle) with a second value of the operating parameter that is generated at a second vehicle and a third value of the operating parameter that is generated at a third vehicle; the second and third vehicles are connected or proximate to the vehicle system 100. If the first value is outside of a designated tolerance and the second value and the third value are within the designated tolerance, the controller 130 is operable to determine that the first value of the operating parameter is corrupted. The designated tolerance may be set to any suitable quantity, depending on the operating parameters being compared. In this manner, in-range failures of these sensors can be detected so mitigation procedures can take place and control of the vehicle system 100 can be based on one of the values of the operating parameter from one of the other vehicles instead of the corrupted value produced by the vehicle system 100.

Example operating parameters that may be shared between vehicles and utilized for controlling engine and/or vehicle operation include GPS position, ambient temperature, barometric (ambient) pressure, ambient humidity, atmospheric constituents (e.g., relative percentages of the specific constituents of air external to the vehicle, such as oxygen and carbon dioxide), and vehicle speed. Note that any suitable operating parameter may be shared between vehicles and used for signal back-up purposes without departing from the scope of the present disclosure.

Operating parameters that indicate environmental conditions surrounding a vehicle may affect operation of the vehicle. As such, controlling engine operation based on such operating parameters may improve engine performance. For example, humidity can affect a peak combustion temperature of an engine. Specifically, a higher humidity can lower the peak combustion temperature, because water vapor absorbs an amount of heat generated from compression/combustion. As such, the controller 138 is operable to adjust operation of the engine 104 by advancing injection timing while still meeting NOx targets when the sensed ambient humidity is higher as compared to when it is lower. In other words, the controller 138 is operable to advance injection timing as ambient humidity increases and retard injection timing as humidity decreases.

Furthermore, ambient humidity can affect gas constituents and EGR. Specifically, due to lower peak combustion temperatures at a higher humidity, EGR that is utilized for cooling, among other affects, may be reduced for a given operating condition. As such, the controller 138 is operable to adjust operation of the engine 104 by reducing an amount of EGR that is provided to the intake manifold 108 when the sensed ambient humidity is higher as compared to when it is lower. In other words, the controller 138 is operable to reduce an EGR amount as ambient humidity increases and increase an EGR amount as ambient humidity decreases.

In another example, ambient pressure can affect operation of the engine 104, and more particularly the engine exhaust backpressure, and thus an amount of combustion residuals that become trapped in the exhaust passage 110. Specifically, lower ambient pressure (e.g., higher altitude) can result in less exhaust backpressure, and thus less trapped residuals. As such, the controller 138 is operable to adjust operation of the engine 104 by increasing an amount of EGR that is provided to the intake manifold 108 when the sensed ambient pressure is lower as compared to when it is higher in order to compensate for the lower trapped residual charge. In other words, the controller 138 is operable to reduce an EGR amount as ambient pressure increases and increase an EGR amount as ambient pressure decreases.

In yet another example, ambient temperature can affect operation of the engine 104, and more particularly manifold air temperature (MAT). Specifically, lower ambient temperatures can result in lower MAT that allows for advancing injection timing while still meeting NOx targets. Moreover, by advancing the injection timing, fuel efficiency may be increased. As such, the controller 138 is operable to adjust operation of the engine 104 by advancing injecting timing when the sensed ambient temperature is lower as compared to when it is higher. In other words, the controller 138 is operable to advance injection timing as ambient temperature decreases and retard injection timing as ambient temperature increases. Moreover, in some embodiments, the controller 138 is operable to advance injection timing based on ambient humidity and temperature in order to improve fuel efficiency while still meeting NOx targets.

In all of the above examples, if the engine controller 138 loses one of those sensed operating parameters that indicate environmental conditions due to unavailability or degradation of the sensor, another value of the operating parameter is received from another engine controller in the consist or train to replace the missing data. By replacing the missing data with values from proximate controllers that receive indications of similar environmental conditions, engine control based on environmental conditions may be accurately maintained even if sensors that sense environmental conditions become degraded or unavailable.

Such operating parameter sharing may be particularly applicable where open loop control is employed for controlling an aspect of an engine based on the operating parameter. Specifically, in open loop control, an operating parameter that indicates an ambient condition is applied as an input to a mathematical function that models a resultant state of the engine without feedback to determine if the output has achieved the desired goal of the input. Due to the lack of feedback in such cases, effectiveness of the open loop control depends on the accuracy of the operating parameter to accurately represent ambient conditions. Accordingly, an operating parameter shared from another proximate vehicle may produce more accurate open loop control than a modeled value of the operating parameter. In one example, the controller 130 is operable to adjust engine speed of the engine 104 of the vehicle system 100 based on an open loop function of which a received value of ambient temperature, barometric pressure, humidity, and/or vehicle speed is an input. The value of any one of these operating parameters is received from a proximate vehicle and used in the event that a first value is unavailable or corrupted, as opposed to using a less accurate modeled value as back-up. In this way, accurate and effective engine control may be maintained even when on-board sensor signal corruption or unavailability occurs.

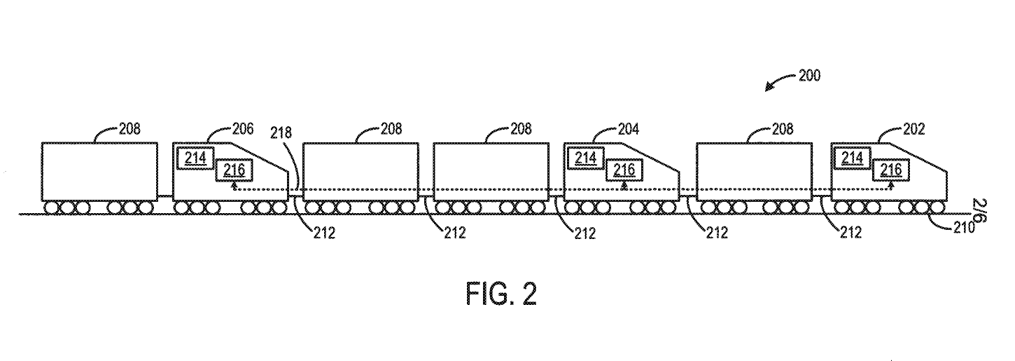

The rail vehicle 106 depicted in FIG. 1 may be one of a plurality of rail vehicles that make up a rail vehicle consist, such as the example train 200 shown in FIG. 2 (a consist is a group of vehicles linked together to travel along a route; a train is one example of a consist). The train 200 includes a plurality of rail vehicles, such as locomotives 202, 204, 206 and a plurality of cars 208, configured to run on the track 210. The plurality of locomotives 202, 204, 206 include a lead locomotive 202 and one or more remote locomotives 204, 206. While the depicted example shows three locomotives and four cars, any appropriate number of locomotives and cars may be included in train 200. Further, in the example the train 200 is traveling to the right, although the train may travel in either direction.

The locomotives 202, 204, 206 are each powered by a respective engine 214, while cars 208 may be non-powered (non-powered meaning not capable of self-propulsion). In one example, locomotives 202, 204, 206 may be diesel-electric locomotives powered by diesel engines. However, in alternate embodiments, the locomotives may be powered with an alternate engine configuration, such as a gasoline engine, a biodiesel engine, a natural gas engine, or wayside (e.g., catenary, or third-rail) electric, for example.

The locomotives 202, 204, 206 and cars 208 are coupled to each other through couplers 212. While the depicted example illustrates locomotives 202, 204, 206 connected to each other through interspersed cars 208, in alternate embodiments, one or more locomotives may be connected in succession, as a consist, while the one or more cars 208 may be coupled to a remote locomotive (that is, a locomotive not in the lead consist) in succession.

Each locomotive may include a communication device 216 that is operable to transmit and receive signals indicative of operating parameters generated by on-board sensors to and from each of the locomotives of the train 200 through a communication link 218. Further, the communication device 216 is operable to send received signals to a controller, such as the controller 130 described above with reference to FIG. 1, for adjusting engine operations of each locomotive. Note that the communication link 218 may enable wired and/or wireless data-sharing between locomotives.

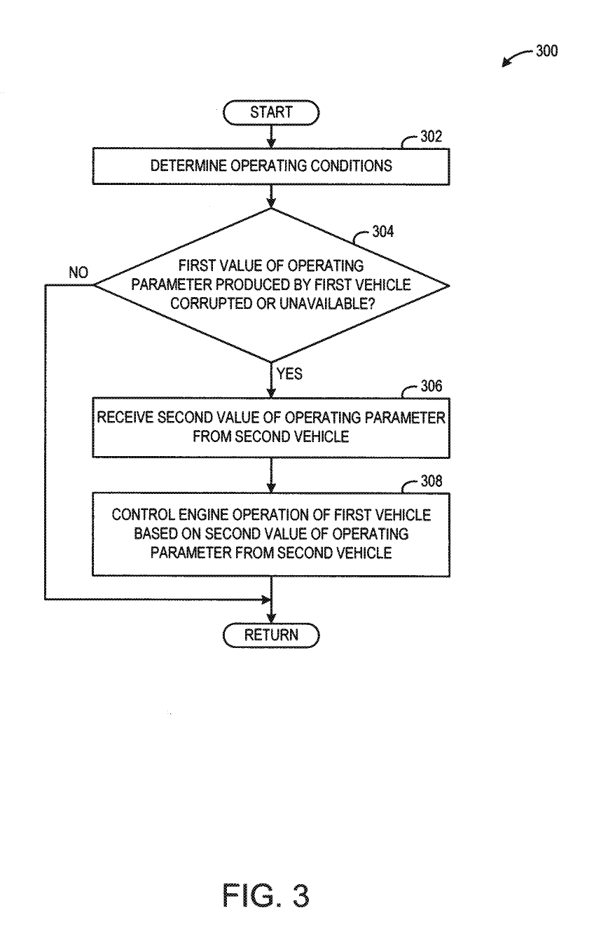

FIG. 3 shows a flow chart illustrating an embodiment of a method 300 for controlling vehicle operation based on data shared between proximate vehicles. In one example, the method 300 is executable by the controller 130 shown in FIG. 1. At step 302, the method 300 includes determining operating conditions. The controller 130 determines operating conditions based on operating parameters indicative of sensor signals received from the sensors 132. For example, signals provided from the sensors 132 that are received by the controller 130 may be indicative of ambient environmental conditions, such as ambient temperature, barometric pressure, humidity, ambient altitude, etc. As another example, signals provided from the sensors 132 that are received by the controller 130 may be indicative of information other than ambient environmental conditions, but still may be shared between vehicles, such as GPS position, vehicle speed, notch position, etc.

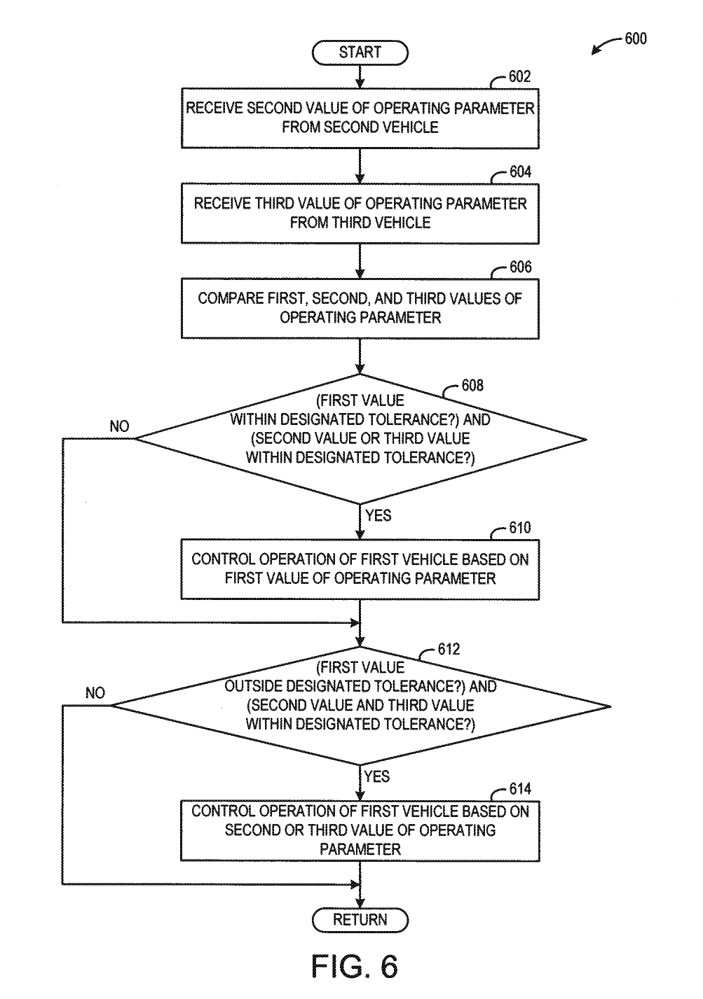

At step 304, the method 300 includes determining whether a first value of an operating parameter produced by a first vehicle is corrupted or unavailable. In one example, the controller 130 performs a comparative in-range failure detection strategy that will be discussed in further detail below with reference to FIG. 6 and method 600. If it is determined that the first value of the sensor signal is unavailable or corrupted, the method 300 moves to step 306. Otherwise, the method 300 returns to other operations.

At step 306, the method 300 includes receiving a second value of the operating parameter that is produced by a second vehicle that is proximate to the first vehicle. In one example, the second vehicle is operatively coupled to the first vehicle, such as rail vehicles connected in a consist. In another example, the second vehicle is not directly coupled to the first vehicle, but instead is distributed in the same train. In each case, the first vehicle and the second vehicle are suitably proximate to each other that they experience substantially the same or similar environmental conditions.

In some implementations, the second value of the operating parameter may be requested from the second vehicle by the controller 130 in response to determination of corruption or unavailability of the first value. In some implementations, the second value may be sent to the controller 130 without receiving a specific request. For example, a designated set of operating parameters may be regularly shared between proximate vehicles as part of an enhancement or back-up strategy. Note the second value can be received through a wired connection or a wireless connection between a communication device of the first vehicle and a communication device of the second vehicle.

At step 308, the method 300 includes controlling operation of an engine of the first vehicle based on the second value of the operating parameter, in response to determining that the first value of the operating parameter is corrupted or unavailable.

In one example, engine control of a rail vehicle is commanded by a notch position that maps to a designated engine speed. In this case, controlling engine operation includes adjusting engine speed based on an open loop function of which the second value of ambient temperature, barometric pressure, and/or vehicle speed is an input. In the event of sensor signal corruption, the shared value of the operating parameter may be employed in the open-loop control strategy, as opposed to reverting to a more traditional back-up model that does not employ current operating conditions, and thus is less accurate and limits engine operation. Note that vehicle speed may be particularly applicable as a shared operating parameter in applications where the first and second vehicles are connected directly or indirectly. In another example, the method may include adjusting injection timing based on ambient humidity. In yet another example, the method may include adjusting an amount of EGR based on ambient humidity. In yet another example, the method may include adjusting an amount of EGR based on ambient pressure. In yet another example, the method may include adjusting injection timing based on ambient temperature.

By leveraging data-sharing among vehicles that are proximate to each other, accurate measurements of the same or similar environmental conditions may be acquired for vehicle control in the event of on-board signal corruption, or the like. In this way, engine operation may be made more robust and performance may be maintained or enhanced in the event of localized sensor signal corruption.

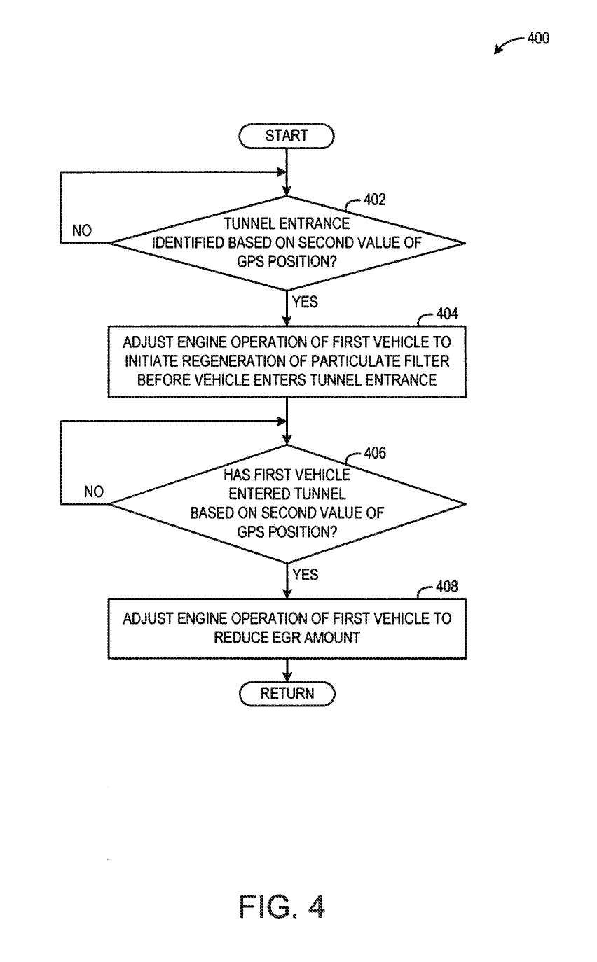

FIG. 4 shows a flow chart illustrating an embodiment of a method 400 for controlling engine operation during tunneling operation. More particularly, the method 400 expands on the method 300 as applied to an example in which a GPS position is shared between proximate rail vehicles, in the event of signal corruption or unavailability to accommodate travel through a tunnel. In one example, the method 400 is executable by the controller 130 shown in FIG. 1. At step 402, the method 400 includes identifying an entrance of a tunnel that is approaching the first vehicle based on the second value of the GPS position. As discussed above, the second value of the GPS position is received from a second vehicle that is proximate to the first vehicle. In one example, the GPS position of the tunnel entrance is identified in a route-feature database that is stored in memory of the controller 130 (or a GPS receiver). The route-feature database may further define features of the tunnel, such as length, grade, etc. In some implementations, the GPS position of the tunnel entrance may be identified relative to the approximate GPS position of the first vehicle. If the tunnel entrance is identified based on the second value of the GPS position, the method 400 moves to step 404. Otherwise, the method returns to step 402.

At step 404, the method 400 includes adjusting operation of the engine of the first vehicle to initiate regeneration of a particulate filter of the first vehicle before the first vehicle enters the entrance of the tunnel. In one example, a rate or amount of particulate filter regeneration may be adjusted based further on a speed of the first vehicle, a state of the particulate filter, etc. Particulate filter regeneration is advantageously performed prior to entering the tunnel in order to prepare the particulate filter for handling an increased amount of particulate matter consumed during travel of the first vehicle through the tunnel, since less fresh air may be available for consumption. In this manner, the first vehicle may travel farther through the tunnel before the particulate filter reaches absorption limits, and engine operation is adjusted to reduce emissions.

At step 406, the method 400 includes determining whether the first vehicle has entered the tunnel based on the second value of the GPS position. If the first vehicle has entered the tunnel, the method 400 moves to step 408. Otherwise, the method 400 returns to step 406.

At step 408, the method 400 includes adjusting operation of the engine of the first vehicle to reduce an amount of exhaust gas recirculation (EGR), in response to determining that the first vehicle has entered the tunnel. One example reason for reducing the amount of EGR during travel through the tunnel is to reduce the likelihood of overwhelming the particulate filter so as reduce the likelihood of increasing emissions.

By controlling operation of the first vehicle based on the GPS position shared from the second vehicle in the event that the GPS position generated on-board the first vehicle is corrupted or unavailable, traditional less accurate tunnel strategies that do not employ GPS position, and thus limit engine output for engine protection, and less reliably control emissions may be avoided.

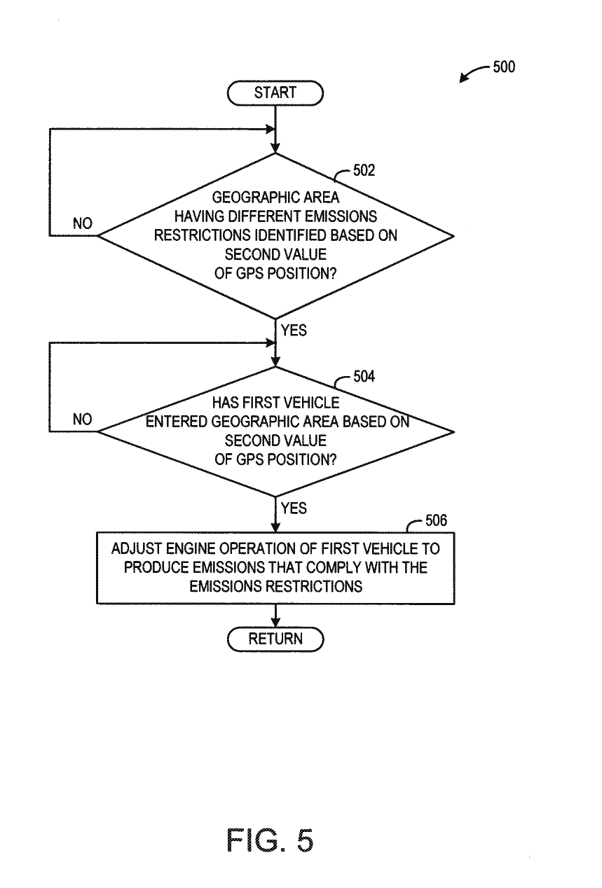

FIG. 5 shows a flow chart illustrating an embodiment of a method 500 for controlling engine operation in an identified geographic area. More particularly, the method 500 expands on the method 300 as applied to an example in which a GPS position is shared between proximate rail vehicles during operation in and around a geographic area that has different emissions restrictions. In one example, the method 500 is executable by the controller 130 shown in FIG. 1. At step 502, the method 500 includes identifying a geographic area having different emissions restrictions based on the second value of the GPS position. As discussed above, the second value of the GPS position is received from a second vehicle that is proximate to the first vehicle. If the geographic area is identified based on the second value of the GPS position, the method 500 moves to step 504. Otherwise, the method returns to step 502.

At step 504, the method 500 includes determining that the first vehicle has entered the geographic area based on the second value of the GPS position. If the first vehicle has entered the geographic area, the method 500 moves to step 506. Otherwise, the method 500 returns to step 504.

At step 506, the method 500 includes adjusting operation of the engine of the first vehicle to produce emissions that comply with the different emissions restrictions, in response to the first vehicle entering the geographic area. In one example, injection timing is adjusted to reduce NOx in order to comply with more strict emissions restrictions. In another example, engine operation is adjusted to increase performance in response to entering a geographic region having less severe emissions restrictions.

By controlling operation of the first vehicle based on the GPS position shared from the second vehicle in the event that the GPS position generated on-board the first vehicle is corrupted or unavailable, geographic emissions restrictions may be obeyed even in the event of sensor signal corruption or unavailability.

FIG. 6 shows a flow chart illustrating an embodiment of a method 600 for diagnosing sensor signal corruption. In some implementations, some or all of the method 600 may be incorporated into the method 300, such as part of the signal corruption determination step 304. In one example, the method 600 is executable by the controller 130 shown in FIG. 1. At step 602, the method 600 includes receiving at a first vehicle, a second value of an operating parameter produced by a second vehicle that is in a consist with the first vehicle.

At step 604, the method 600 includes receiving a third value of the operating parameter produced by a third vehicle that is in the consist with the first vehicle.

At step 606, the method includes comparing the first value, the second value, and the third value of the same operating parameter.

At step 608, the method 600 includes determining whether the first value is within a designated tolerance and the second value or the third value is within the designated tolerance. The designated tolerance may be set to any suitable value and may be adjusted to accommodate various different vehicle configurations. If the first value is within the designated tolerance and the second value or the third value are within the designated tolerance, the method 600 moves to step 610. Otherwise, the method 600 moves to step 612.

At step 610, the method 600 includes controlling operation of the first vehicle based on the first value of the operating parameter. The first value is determined to not be corrupted, because it is confirmed as being accurate by at least one of the other values.

At step 612, the method 600 includes determining whether the first value is outside the designated tolerance and the second value and the third value is within the designated tolerance. If the first value is outside the designated tolerance and the second value and the third value are within the designated tolerance, the method 600 moves to step 614. Otherwise, the method 600 returns to other operations.

At step 614, the method 600 includes controlling operation of the first vehicle based on the second value or the third value of the operating parameter. Since the first value of the operating parameter does not match (e.g., the other two values are within the designated tolerance, but the first value is outside the designated tolerance), then the first value should be considered corrupted, and control can be performed based on the values from the healthy sensors on the other vehicles.

By comparing values of the same operating parameter from different sensors on different vehicles that are proximate to each other, failures of these sensors can be detected, and the corrupted sensor signals can be replaced by signals from a healthy sensor on a proximate vehicle, as opposed to reverting to a less accurate back-up value that does not utilize current sensor information. In this fashion, in-range failures of these sensors can be detected so mitigation procedures can take place, if needed.

In an embodiment, a value of an operating parameter is assessed by comparing the value to one or more established criteria, e.g., the criteria are pre-defined and stored in a memory of a control module. If the value does not meet the one or more criteria, then the value is deemed corrupted, e.g., not having reliable or useable data content, and a second value from another vehicle is used for engine control. For example, for a value of sensed ambient temperature, the criteria may comprise: a range of possible external temperatures, based on worldwide extremes; a range of possible external temperatures for a geographical region in which a vehicle is designated for travel, possibly adjusted as a function of time of day, date, and/or season; a range of possible temperatures based on data received from an off-board source, e.g., expected high and low temperatures for a given calendar date modified by an error threshold; or the like.

In another embodiment, a value of an operating parameter is assessed by comparing the value to a designated format for the type of data represented by the value. If the value does not match the designated format, then it is deemed corrupted. For example, in a given vehicle system, if a temperature sensor reports a temperature (in degrees C.) to one decimal point accuracy, then a value having more than three digits (excluding indicators of positive or negative), for example, more than +99.9 or less than −99.9 deg C., might be deemed corrupted.

In another embodiment, a value of an operating parameter is assessed for being unavailable based on a null value. That is, in embodiments, a null value (absence of a returned value) is considered a value for purposes of assessing using another value from another vehicle for engine control purposes, as described herein. Thus, upon the occurrence of a null value at a first vehicle, the value is deemed unavailable, and a value from another, second vehicle is used for engine control purposes at the first vehicle.

Another embodiment relates to a system comprising a control module that is configured for deployment in a vehicle (e.g., first vehicle). For example, the control module may comprise a vehicle controller, or a software/hardware module configured to interface (communicate) with a vehicle controller. The control module is further configured to receive, from a sensing device in the first vehicle, a first value of a condition sensed by the sensing device. For example, the condition may be an ambient environmental condition, such as a temperature, humidity level, pressure, or gas constituent makeup of air external to the vehicle. The control module is further configured to determine whether the first value meets one or more criteria, and, in response to determining that the first value meets the one or more criteria, control operation of an engine of the first vehicle based on a second value of the condition received from a second vehicle. For example, the first and second vehicles may be linked in a consist, or may otherwise be proximate to one another. The one or more criteria, for example, may be indicative of the first value being unavailable, corrupted, or otherwise unusable for vehicle control, e.g., based on the first value not matching second and third values within a threshold (as described above), failing to match a designated format, falling outside a designated range of likely or expected values, being a null value, or the like. As noted, the control module may be a hardware and/or software module, meaning it may comprise: interconnected electronic components configured to carry out one or more designated functions (e.g., receive input signals, and generate output/control signals based on the input signals); and/or software, meaning one or more sets of electronically readable instructions, stored in non-transitory media/medium, that when read and executed by an electronic device (group of interconnected electronic components) cause the electronic device to perform one or more functions according to the contents of the instructions.

In another embodiment, the condition (of the first value) is an ambient environmental condition, and the control module is configured to determine whether the first value is unavailable or corrupted. If the first value is unavailable or corrupted, the control module is further configured to control the engine (of the first vehicle) based on a second value of the ambient environmental condition, which is received from a second vehicle. Thus, the control module is configured to receive the first value from the sensing device, determine whether the first value is corrupted or unavailable, receive the second value, e.g., from a communication device on board the first vehicle, and in response to determining that the first value\is corrupted or unavailable, control operation of an engine of the first vehicle based on the second value.

In the present description and the appended claims, the terms “first,” “second,” “third,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method comprising:
determining whether a first value of an operating parameter indicative of an ambient environmental condition is corrupted or unavailable, wherein the first value is produced by a first vehicle;
receiving a second value of the operating parameter that is indicative of the ambient environmental condition, wherein the second value is produced by a second vehicle that is proximate to the first vehicle; and
in response to determining that the first value is corrupted or unavailable, controlling operation of an engine of the first vehicle based on the second value of the operating parameter.

2. The method of claim 1, wherein the operating parameter that is indicative of the ambient environmental condition includes ambient temperature.

3. The method of claim 1, wherein the operating parameter that is indicative of the ambient environmental condition includes barometric pressure.

4. The method of claim 1, wherein the operating parameter that is indicative of the ambient environmental condition includes humidity.

5. The method of claim 1, further comprising:
adjusting engine speed of the engine of the first vehicle based on an open loop function of which the second value is an input.

6. The method of claim 1, further comprising:
receiving a third value of the operating parameter that is indicative of the ambient environmental condition, wherein the third value is produced by a third vehicle that is proximate to the first vehicle; and
if the first value is outside of a designated tolerance and the second value and the third value are within the designated tolerance, determining that the first value of the operating parameter is corrupted.

7. The method of claim 1, wherein the first vehicle and the second vehicle are rail vehicles at least one of directly connected in a consist or connected within a train.

8. The method of claim 1, further comprising:
determining that a first value of a global positioning system (GPS) position produced by the first vehicle is corrupted or unavailable;
receiving a second value of the GPS position produced by the second vehicle that is proximate to the first vehicle; and
in response to determining that the first value is corrupted or unavailable, controlling operation of the engine of the first vehicle based on the second value of the GPS position.

9. The method of claim 1, further comprising:
determining that a first value of vehicle speed produced by the first vehicle is corrupted or unavailable;
receiving a second value of vehicle speed, the second value produced by the second vehicle that is proximate to the first vehicle; and
in response to determining that the first value is corrupted or unavailable, controlling operation of the engine of the first vehicle based on the second value of the vehicle speed.

10. A system comprising:
a control module configured for deployment in a first vehicle and to receive, from a sensing device in the first vehicle, a first value of a condition sensed by the sensing device; and
wherein the control module is further configured to determine whether the first value meets one or more criteria, and, in response to determining that the first value meets the one or more criteria, control operation of an engine of the first vehicle based on a second value of the condition received from a second vehicle.

11. A system comprising:
a first vehicle, proximate to a second vehicle, comprising:
an engine;
a sensing device operable to produce a first value of an operating parameter that is indicative of an ambient environmental condition;
a communication device operable to receive a second value of the operating parameter that is indicative of an ambient environmental condition from the second vehicle; and
a controller operable to determine whether the first value of the operating parameter is corrupted or unavailable, and in response to determining that the first value of the operating parameter is corrupted or unavailable, control operation of the engine based on the second value of the operating parameter.

12. The system of claim 11, wherein the operating parameter that is indicative of the ambient environmental condition includes ambient temperature.

13. The system of claim 11, wherein the operating parameter that is indicative of the ambient environmental condition includes barometric pressure.

14. The system of claim 11, wherein the operating parameter that is indicative of the ambient environmental condition includes humidity.

15. The system of claim 11, wherein the controller is operable to adjust engine speed of the first vehicle based on an open loop function of which the second value is an input.

16. The system of claim 11, wherein the communication device is operable to receive a third value of the operating parameter from a third vehicle that is proximate to the first vehicle, and the controller is operable to compare the first value with the second value and the third value, and if the first value is outside of a designated tolerance and the second value and the third value are within the designated tolerance determine that the first value of the operating parameter is corrupted.

17. The system of claim 11, wherein the first vehicle and the second vehicle are rail vehicles at least one of directly connected in a consist or connected within a train.

18. A method comprising:
determining whether a first value of a GPS position produced by a first vehicle is corrupted or unavailable;
receiving a second value of the GPS position produced by a second vehicle that is proximate to the first vehicle;
in response to determining that the first value is corrupted or unavailable, identifying a tunnel based on the second value of the GPS position; and
controlling operation of an engine of the first vehicle based on the second value of the GPS position to travel through the tunnel.

19. The method of claim 18, wherein identifying the tunnel includes identifying an entrance of the tunnel that is approaching the first vehicle based on the second value of the GPS position, and controlling operation includes, in response to identifying the entrance, adjusting operation of the engine of the first vehicle to initiate regeneration of a particulate filter of the first vehicle before the first vehicle enters the entrance of the tunnel.

20. The method of claim 19, further comprising:
determining that the first vehicle has entered the tunnel based on the second value of the GPS position; and
in response to determining that the first vehicle has entered the tunnel, adjusting operation of the engine of the first vehicle to reduce an amount of exhaust gas recirculation (EGR).

21. The method of claim 18, further comprising:
identifying a geographic area having different emissions restrictions based on the second value of the GPS position;
determining that the first vehicle has entered the geographic area based on the second value of the GPS position; and
in response to determining that the first vehicle has entered the geographic area, adjusting operation of the engine of the first vehicle to produce emissions that comply with the different emissions restrictions.

22. The method of claim 18, wherein determining includes receiving a third value of the GPS position produced by a third vehicle that is in a consist with the first vehicle, and if the first value is outside of a designated tolerance and the second value and the third value are within the designated tolerance, determining that the first value of the GPS position is corrupted.
